(19) United States
(12) Patent Application Publication
(10) Pub. No.: US 2016/0299278 A1
(43) Pub. Date: Oct. 13, 2016

(54) KEYBOARD BACKLIGHT MODULE ASSEMBLY WITH SIDE LIGHT LEAKPROOF FUNCTION

(71) Applicant: CHICONY POWER TECHNOLOGY CO., LTD., New Taipei City (TW)

(72) Inventor: Hsin-Chih LIANG, New Taipei City (TW)

(21) Appl. No.: 14/864,470

(22) Filed: Sep. 24, 2015

(30) Foreign Application Priority Data
Apr. 7, 2015 (CN) 201520203387.0

(51) Int. Cl. F21V 8/00; G06F 3/02

(52) U.S. Cl. CPC G02B 6/0021; G02B 6/0073; G02B 6/0065; G02B 6/0055; G06F 3/0202

(57) ABSTRACT

A keyboard backlight module assembly includes a keyboard carrying a set of key switches and a backlight module including a light-shielding layer, a light-guiding layer and a reflecting layer arranged into a laminated structure. The light-guiding layer has through holes and a light-blocking structure located at three of four peripheral sides thereof and the border edge around each of selected through holes and formed of a part of the external surface of the light-guiding layer using a laser-based processing technique for preventing light leakage and enabling emitted light from LEDs to be concentrated onto key switches of the keyboard.

This application claims the priority benefit of China patent application number 201520203387.0 filed on Apr. 7, 2015

### BACKGROUND OF THE INVENTION

1. Field of the Invention

The present invention relates to keyboard technology and more particularly, to a keyboard backlight module assembly with side light leakproof function, which provides a light-blocking structure made by carbonizing or crystallizing at least three of the four peripheral sides and the border edge around each of selected through holes of the light-guiding layer of the backlight module thereof using a laser-based processing technique.

2. Description of the Related Art

With fast development of the modern technology, many different kinds of electrical and electronic products have been created and widely used in our daily life, bringing comfort and convenience to people and improving the standard of living of the people. The jobs of word processing, photos and graphics editing, presentations, e-mail, Internet linking, and etc. are quite common in our everyday lives, making the application of computer products become more popular. In various electronic works through a computer system, one must input data through a keyboard, so that the host of the computer system can start processing according to the inputted data. Therefore, a computer keyboard has become an essential tool for the computer jobs. It is now the market trend to design computers and peripheral apparatuses having light, thin, short and small characteristics and enhanced functions, the overall thickness of a computer, more particularly, notebook computer, must be greatly reduced. In consequence, the thickness of computer display screens and keyboards must also be greatly reduced. Nowadays, low profile membrane keyboards have been widely used in various computer products to replace conventional mechanical keyboards. Further, a computer keyboard can have a light source mounted therein for emitting light to each key switch that is pressed by the user so that the user can clearly identify the location of the key switch that is duly pressed. A light-emitting keyboard structure generally comprises a light-shielding layer, a light-guiding layer and a reflective layer arranged into a laminated structure beneath the key switches, and a plurality of light-emitting diodes mounted in the circuit board of the light guide layer. The reflective layer is adapted to reflect the emitted light of the light-emitting diodes upwardly. The light-shielding layer masks the reflected light in predetermined areas so that the reflected light can be concentrated and upwardly guided to each pressed key switch or the area around each pressed key switch. The light-shielding layer, the light-guiding layer and the reflective layer constitute a backlight reflecting layer. Further, the light-shielding layer has holes corresponding to the key switches of the keyboard so that the reflective layer can reflect the light in the light-guiding layer toward the key switches through the holes in the light-shielding layer. However, the peripheral sides of the laminated structure of the light-shielding layer, light-guiding layer and reflecting layer are light transmissive. Thus, light entered the light-guiding layer can leak through the peripheral sides of the laminated structure, causing light energy attenuation and lowering the visibility of the symbols or marks at the key switches.

A keyboard backlight module, entitled “light-emitting keyboard”, as illustrated in FIG. 6, this design of light-emitting keyboard A comprises: a light guide plate A1, configured with a light entrance surface A11, a light emitting surface A12, a bottom surface A13 and a side surface A14; a light source A2, disposed next to the light entrance surface A11 of the light guide plate A1; a bottom surface A13, disposed on the light emitting surface A12 of the light guide plate A1; a first reflecting layer A3, disposed on the bottom surface A13 of the light guide plate A1; and a second reflecting layer A4, disposed on the side surface A14 of the light guide plate A1. With the aforesaid structure, light A21 from the light source A2 can be projected into the light guide plate A1, enabling light A21 to be refracted in the light guide plate A1 and reflected by the first reflecting layer A3 of the bottom surface A13 toward the light-shielding layer B and the keyboard C. At this time, the second reflecting layer A4 on the side surface A14 of the light guide plate A1 reflects lateral leaking light A21 toward the inside of the light guide plate A1. However, because light A21 is repeatedly reflected and refracted in the light guide plate A1, the energy of light A21 is attenuated before reaching the keyboard C. Thus, after the light guide plate A1 guided light A21 to the light-shielding layer B and the keyboard C above the light guide plate A1, the brightness of light A21 gets reduced, unable to brightly light up the keyboard C.

Further, an improved structure of light guide plate for keyboard as illustrated in FIGS. 7-9, the light guide plate D comprises a plurality of through holes D1 and blind holes D2 disposed near the border area thereof, and a light-absorbing ink D12,D22 coated on the inner wall surfaces D11,D21 of the through holes D1 and blind holes D2. When the light source E is activated to emit light into the light guide plate D, the bottom side of reflecting layer F reflects light upwards, light-absorbing ink D12,D22 at the inner wall surfaces D11,D21 of the through holes D1 and blind holes D2 absorb a part of the reflected light from the reflecting layer F, preventing light from leaking through the peripheral sides of the light guide plate D. However, because the light-absorbing ink D12,D22 absorbs a part of the light emitted by the light source E, attenuating the energy of light in the light guide plate D and reducing the brightness of the keyboard illumination. The above-described prior art light-emitting keyboard A and light guide plate D can prevent side light-leakage, however, the energy of the emitted light will be attenuated before reaching the keyboard C, reducing the brightness of the keyboard illumination.

Therefore, it is desirable to provide a keyboard backlight design, which prevents side light-leakage without attenuating the energy of the emitted light for lighting up the keyboard.

### SUMMARY OF THE INVENTION

The present invention has been accomplished under the circumstances in view. It is therefore the main object of the present invention to provide a keyboard backlight module assembly with side light leakproof function, which provides a light-blocking structure made at the light-guiding layer of the backlight module thereof using a laser-based processing technique for preventing side light-leakage and enabling incident light to be efficiently guided to the key switches of the keyboard thereof.

To achieve this and other objects of the present invention, a keyboard backlight module assembly comprises a keyboard carrying a set of key switches, and a backlight module mounted at the bottom side of the keyboard. The backlight module comprises a light-shielding layer, a light-guiding layer and a reflecting layer arranged into a laminated structure, and a circuit board sandwiched in between the light-guiding layer and the reflecting layer and carrying a plurality of light-emitting components. The light-guiding layer of the backlight module has at least three of the four peripheral sides thereof processed to create the desired light-blocking structure using a laser-based processing technique. The light-blocking structure prevents side light-leakage, enabling the light-guiding layer to effectively guide incident light toward the key switches without causing light energy attenuation, enhancing the visibility of the key switches.

Preferably, the light-guiding layer of the backlight module is made from polycarbonate (PC) or polymethyl methacrylate (PMMA), having at least three of the four peripheral sides thereof carbonized or crystallized to create the desired light-blocking structure using the laser-based processing technique. Thus, emitted light from the light-emitting components (LEDs) can be effectively guided through the through holes of the light-guiding layer to illuminate the respective key switches of the keyboard, enhancing the visibility of the key switches.

Further, the laser-based processing technique is to apply a laser light to carbonize or crystallize at least three of the four peripheral sides thereof of the backlight module, creating the desired light-blocking structure for preventing side light-leakage. The wavelength of the laser light can be selected in the range of 1350˜1400 nm or 1550˜1650 nm according to the material property of the light-guiding layer of the backlight module that can be selectively made from polycarbonate (PC) or polymethyl methacrylate (PMMA).

Further, the light-guiding layer of the backlight module has a plurality of through holes cut through opposing top and bottom surfaces thereof corresponding to the key switches of the keyboard. The border edge around each of selected ones of the through holes is also processed to create a light-blocking structure for preventing incident light from leaking through the border edge of each of the selected through holes.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an elevational view of a light-guiding layer of a backlight module of a keyboard backlight module assembly in accordance with the present invention.

FIG. 2 is an exploded view of the backlight module of the keyboard backlight module assembly in accordance with the present invention.

FIG. 3 is a sectional view of a part of the backlight module of the keyboard backlight module assembly in accordance with the present invention.

FIG. 4 is an exploded view of the keyboard backlight module assembly in accordance with the present invention.

FIG. 5 is a sectional side view of the keyboard backlight module assembly in accordance with the present invention.

FIG. 6 is a sectional side view of a light-emitting keyboard according to the prior art.

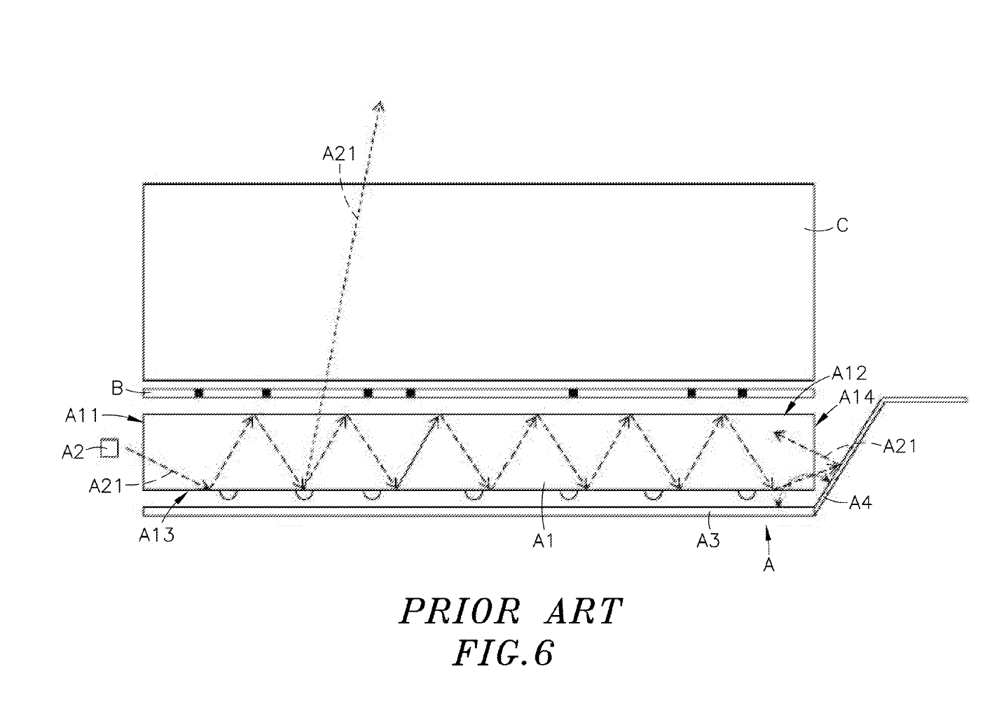

FIG. 7 is a top view of another design of backlight module according to the prior art.

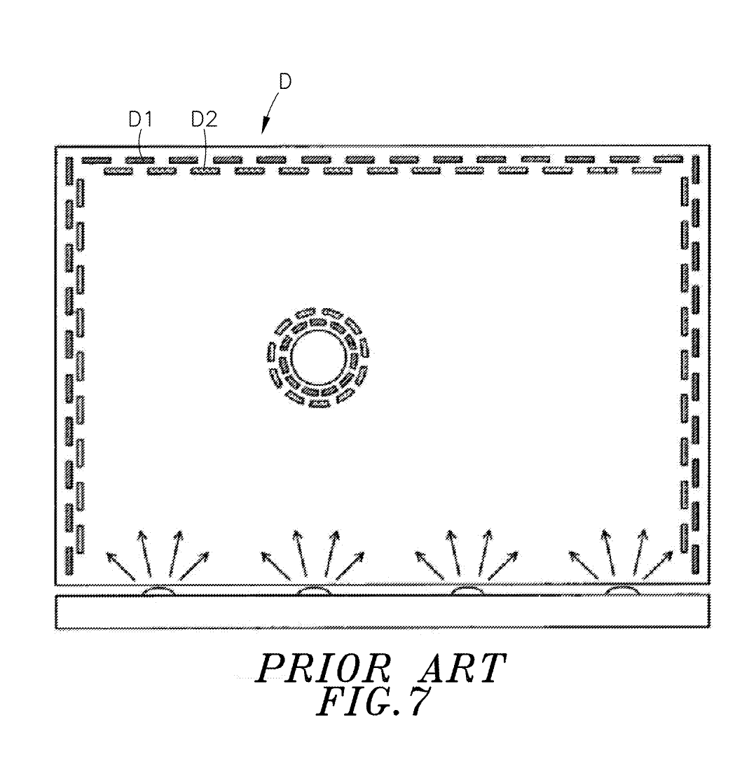

FIG. 8 is a sectional side view of the prior art backlight module shown in FIG. 7 (I).

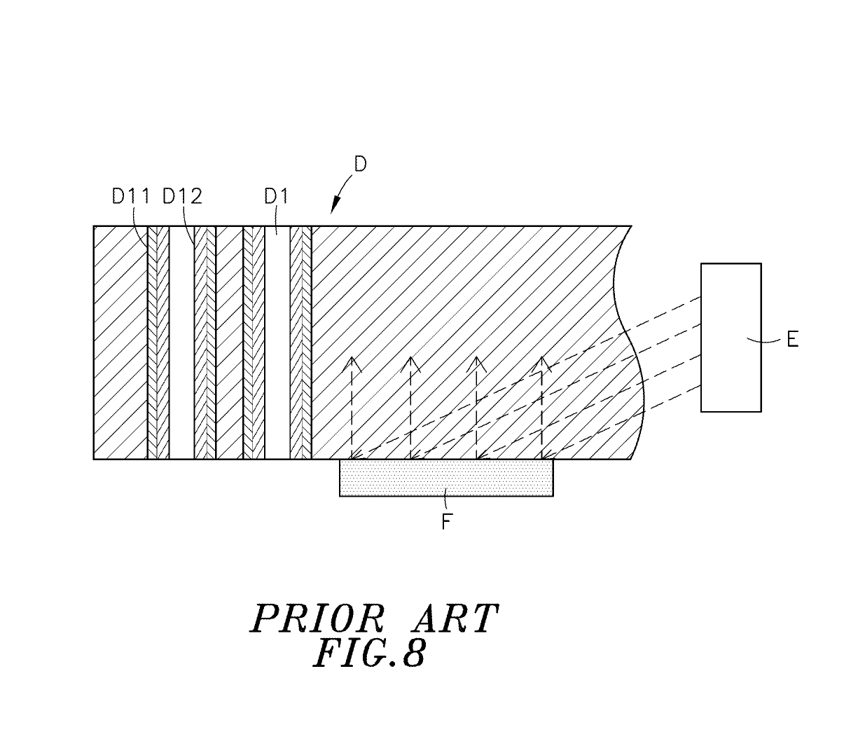

FIG. 9 is a sectional side view of the prior art backlight module shown in FIG. 7 (II).

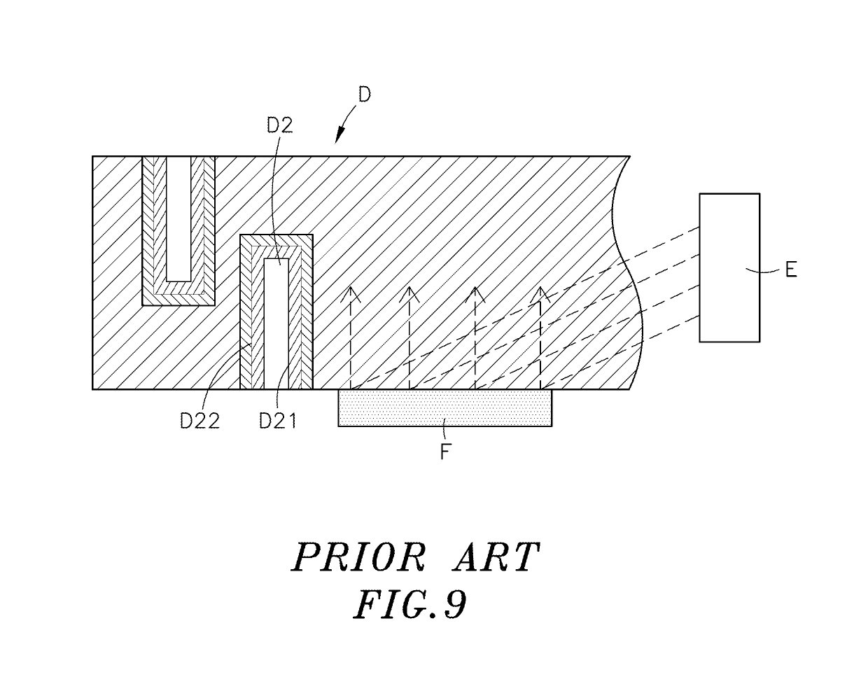

### DETAILED DESCRIPTION OF THE PREFERRED EMBODIMENT

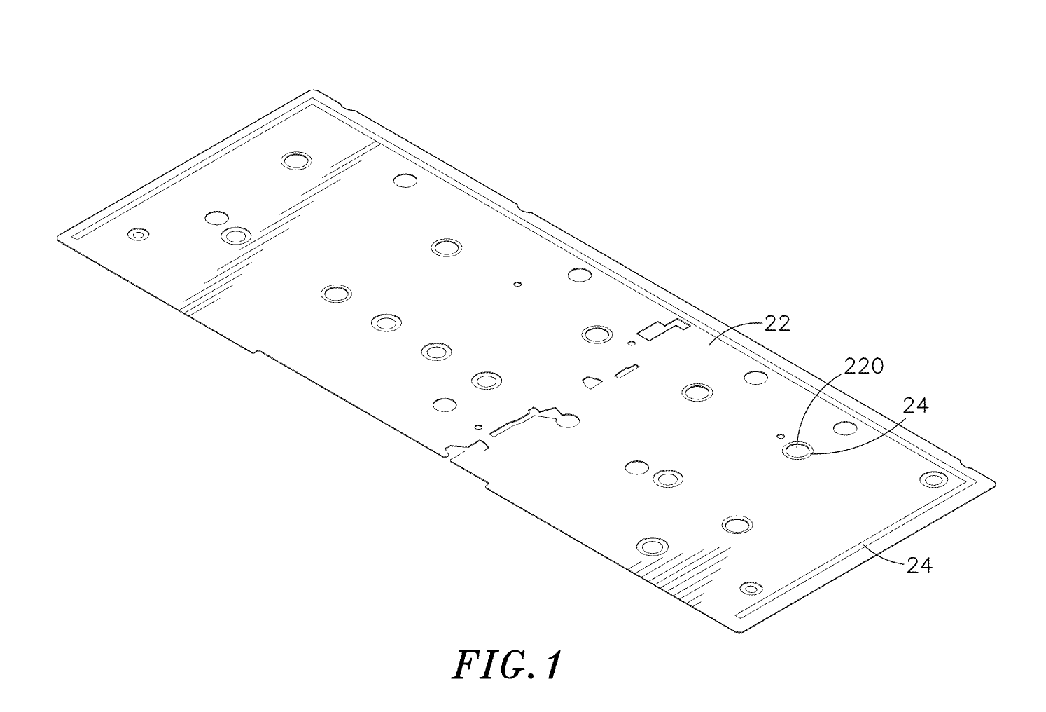

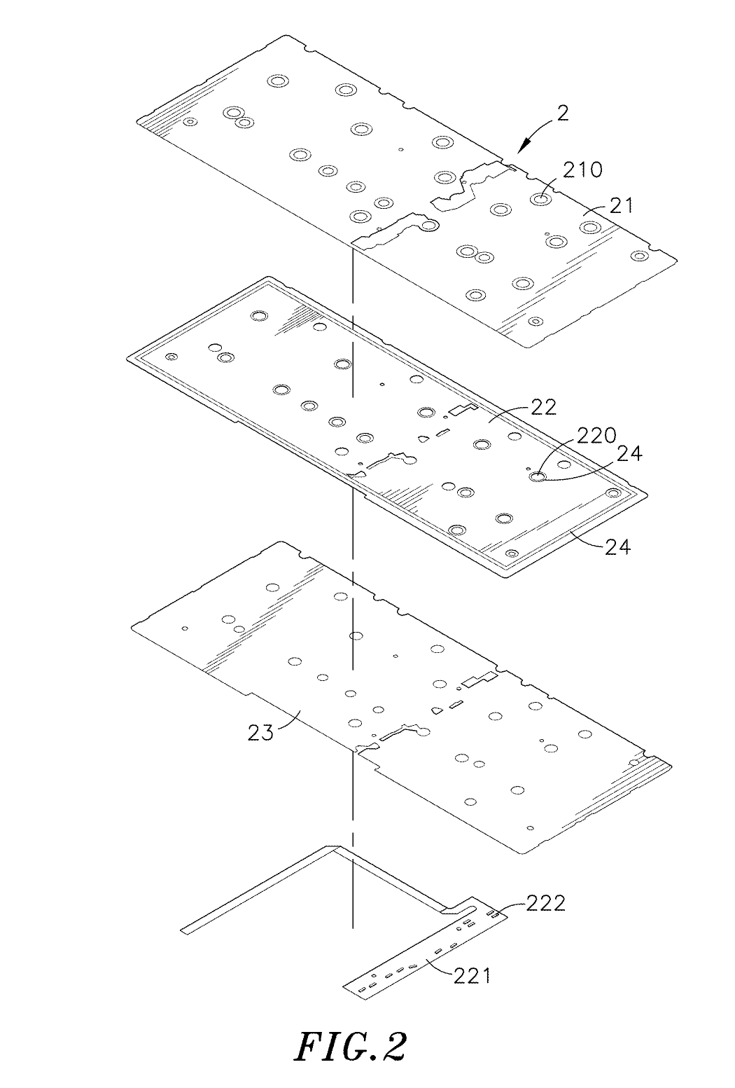

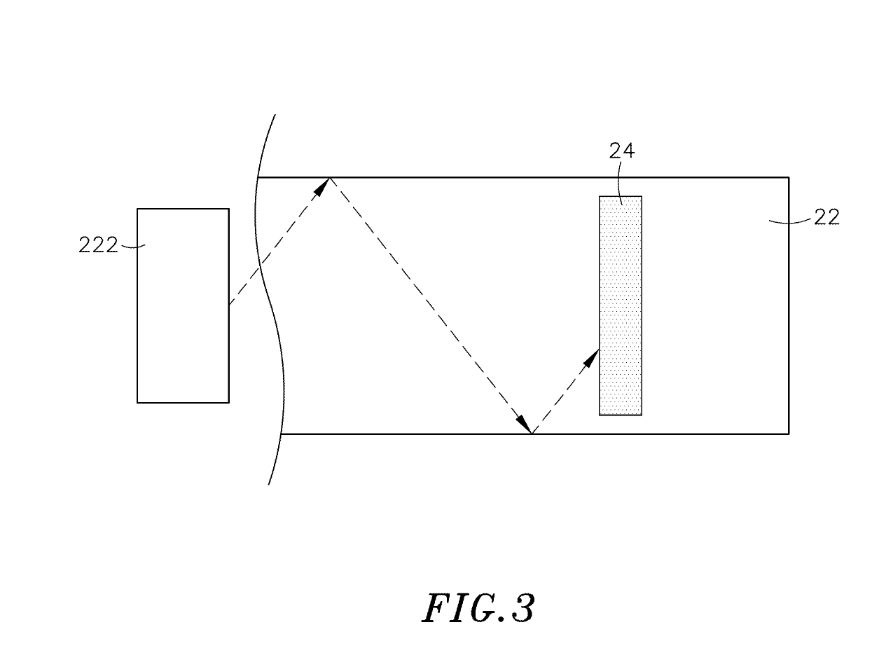

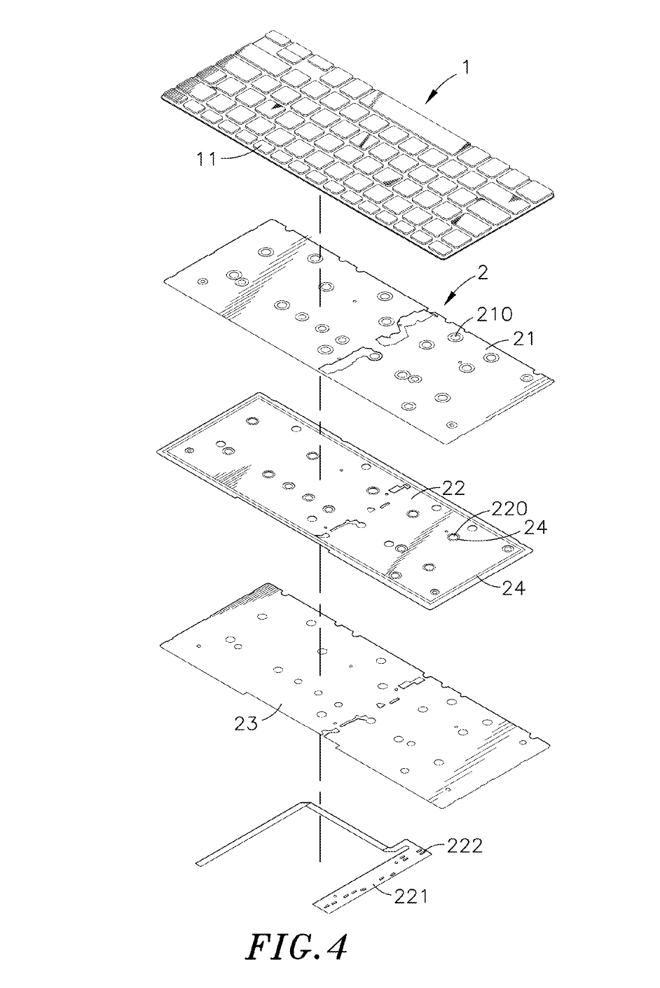

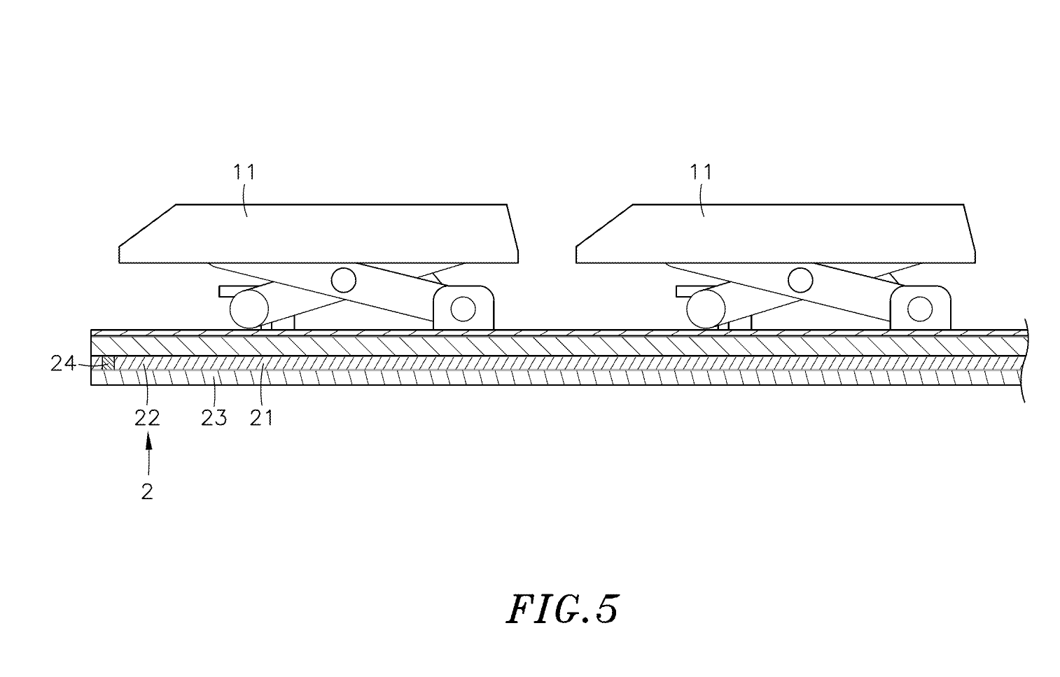

Referring to FIGS. 1-5, an elevational view of a light-guiding layer of a backlight module of a keyboard backlight module assembly in accordance with the present invention, an exploded view of the backlight module of the keyboard backlight module assembly, a sectional view of a part of the backlight module of the keyboard backlight module assembly, an exploded view of the keyboard backlight module assembly and a sectional side view of the keyboard backlight module assembly are shown. As illustrated, the keyboard backlight module assembly comprises a keyboard 1, and a backlight module 2 mounted at a bottom side of the keyboard 1.

The keyboard 1 comprises a set of key switches 11. The backlight module 2 is mounted at the bottom side of the keyboard 1 beneath the key switches 11. Further, the backlight module 2 comprises a light-shielding layer 21, a light-guiding layer 22 and a reflecting layer 23 arranged into a laminated structure, and a circuit board 221 sandwiched in between the light-guiding layer 22 and the reflecting layer 23 and carrying a plurality of light-emitting components 222 that can be, for example, light-emitting diodes (LEDs) operable to emit light toward the inside of the light-guiding layer 22 that distributes incident light uniformly to the whole surface thereof.

The light-guiding layer 22 of the backlight module 2 is made from polycarbonate (PC), polymethyl methacrylate (PMMA) or like polymers, comprising a plurality of through holes 220 cut through opposing top and bottom surfaces thereof. Further, the external surfaced of the light-guiding layer 22 around at least three of the four peripheral sides of the light-guiding layer 22 and the border edge around each of selected ones of the through holes 220 are processed to create a light-blocking structure 24 using a laser-based processing technique. Preferably, the light-blocking structure 24 is located at all of the four peripheral sides of the light-guiding layer 22 and the border edge around each of selected ones of the through holes 220 for preventing side light-leakage so that the light-guiding layer 22 can effectively and accurately guide emitted light toward the key switches 11 without causing light energy attenuation.

Further, laser light of wavelength in the range of 1150˜1250 nm or 1350˜1400 nm, or preferably, in the range of 1550˜1650 nm can be selected according to the type of the material of the light-guiding layer 22 and applied to carbonize or crystallize selected area of the external surface of the light-guiding layer 22 for creating the desired light-blocking structure 24, enabling the created light-blocking structure 24 to be located around at least three of the four peripheral sides of the light-guiding layer 22 and the border edge around each of selected ones of the through holes 220 to prevent side light-leakage.

Further, the light-shielding layer 21 of the backlight module 2 is attached to the bottom side of the keyboard 1, comprising a plurality of light-transmitting holes 210 respectively aimed at the key switches 11 of the keyboard 1. During operation, the light-emitting components 222 of the circuit board 221 light-guiding layer 22 are selectively activated to emit light toward the light-guiding layer 22. At this time, the light-blocking structure 24 prevents incident light from leaking through the peripheral sides of the light-guiding layer 22 or the border edge around each through hole 220, enabling incident light to be concentrated and guided through the through holes 220 and the respective light-transmitting holes 210 of the light-shielding layer 21 to illuminate the respective key switches 11 of the keyboard 1 without causing light energy attenuation, thereby enhancing the visibility of the key switches 11.

As illustrated above, a laser-based processing technique is employed to process three (or all) of the four peripheral sides of the light-guiding layer 22 and the border edge around each of selected ones of the through holes 220, creating the desired light-blocking structure 24 for preventing incident light from leaking through the peripheral sides of the light-guiding layer 22 or the border edge of each through hole 220 without causing light energy attenuation. Thus, creating the desired light-blocking structure 24 does not need to change the laminated structure of the light-shielding layer 21, light-guiding layer 22 and reflecting layer 23 of the backlight module 2 or to add extra components, and will not cause changes in the size of the backlight module 2, facilitating assembling the backlight module 2 with the keyboard 1 in compliance with the design concept of being light, thin, short, and small.

As described above, the backlight module 2 of the keyboard backlight module assembly is mounted at the bottom side of the keyboard 1 beneath the key switches 11; the light-guiding layer 22 of the backlight module 2 has at least three of the four peripheral sides and the border edge around each of selected ones of the through holes 220 processed to create the desired light-blocking structure 24 using a laser-based processing technique. When one or multiple selected light-emitting components 222 are controlled to emit light into the light-guiding layer 22, the light-blocking structure 24 at the peripheral sides of the light-guiding layer 22 prevents side light-leakage, enabling the light-guiding layer 22 to effectively guide incident light toward the respective key switches 11 at the keyboard 1 above the light-shielding layer 21, enhancing the visibility of the respective key switches 11.

In conclusion, the invention provides a keyboard backlight module assembly with side light leakproof function, which comprises a keyboard carrying a set of key switches, and a backlight module mounted at the bottom side of the keyboard and comprising a light-shielding layer, a light-guiding layer and a reflecting layer arranged into a laminated structure, and a circuit board sandwiched in between the light-guiding layer and the reflecting layer and carrying a plurality of light-emitting components, wherein the light-guiding layer of the backlight module has at least three of the four peripheral sides thereof and the border edge around each of selected ones of the through holes thereof processed to create the desired light-blocking structure using a laser-based processing technique. The light-blocking structure prevents side light-leakage, enabling the light-guiding layer to effectively guide incident light toward the key switches without causing light energy attenuation, enhancing the visibility of the key switches.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A keyboard backlight module assembly, comprising a keyboard, and a backlight module mounted at a bottom side of said keyboard, wherein:
said backlight module comprises a light-blocking structure located at at least a part of the border area of a light-guiding layer thereof for blocking light, said light-blocking structure being formed of a part of the external surface of said light-guiding layer using a laser-based processing technique.

2. The keyboard backlight module assembly as claimed in claim 1, wherein said light-blocking structure is located at least three of four peripheral sides of said light-guiding layer.

3. The keyboard backlight module assembly as claimed in claim 1, wherein said light-guiding layer is selected made from polycarbonate (PC) or polymethyl methacrylate (PMMA), having three of four peripheral sides thereof processed to form a part of said light-blocking structure using said laser-based processing technique.

4. The keyboard backlight module assembly as claimed in claim 1, wherein said light-guiding layer of said backlight module further comprises a plurality of through holes cut through opposing top and bottom surfaces thereof; said light-blocking structure has a part thereof located around the border edge of each of selected ones of said through hole.

5. A keyboard backlight module assembly, comprising a keyboard and a backlight module mounted at a bottom side of said keyboard, said backlight module comprising a reflecting layer, a light-guiding layer and a light-shielding layer arranged into a laminated structure, wherein:
said light-guiding layer of said backlight module comprises a light-blocking structure located at at least three of four peripheral sides thereof, said light-blocking structure being formed of a part of the external surface of said light-guiding layer using a laser-based processing technique.

6. The keyboard backlight module assembly as claimed in claim 5, wherein said light-blocking structure is located at all the four peripheral sides of said light-guiding layer.

7. The keyboard backlight module assembly as claimed in claim 5, wherein said light-guiding layer is selected made from polycarbonate (PC) or polymethyl methacrylate (PMMA), having all four peripheral sides thereof processed to form a part of said light-blocking structure using said laser-based processing technique.

8. The keyboard backlight module assembly as claimed in claim 5, wherein said light-guiding layer of said backlight module further comprises a plurality of through holes cut through opposing top and bottom surfaces thereof; said light-blocking structure has a part thereof located around the border edge of each of selected ones of said through hole.
